(19) United States
(12) Patent Application Publication
(10) Pub. No.: US 2010/0229743 A1
(43) Pub. Date: Sep. 16, 2010

(54) METHOD OF MANUFACTURING CERAMIC ELECTRONIC COMPONENTS AT HIGH SPEED THROUGH PRINTING PROCESS

(75) Inventors: Kee-Hyun Shin, Seongnam (KR); Sung-Lim Ko, Seoul (KR); Hyun-Kyoo Kang, Goyang (KR); Jae-Ho Choi, Seoul (KR)

Correspondence Address: LRK Patent Law Firm, 1952 Gallows Rd, Suite 200, Vienna, VA, 22182, US

(73) Assignee: KONKUK UNIVERSITY INDUSTRIAL COOPERATION CORP., Seoul (KR)

(21) Appl. No.: 12/680,569

(22) PCT Filed: Jan. 16, 2008
(86) PCT No.: PCT/KR08/00280

§ 371 Date: Mar. 27, 2010

(30) Foreign Application Priority Data
Oct. 4, 2007 (KR) 10-2007-0100068

(51) Int. Cl. B41M 1/10

(52) U.S. Cl. 101/170

(57) ABSTRACT

Disclosed is a method of manufacturing electronic components, particularly, a method of manufacturing electronic components through a printing process, including simultaneously printing ceramic dielectric regions and conductive regions on a support film. The manufacturing method repeats gravure printing of a ceramic dielectric paste and a conductive paste on a support film, without the use of a ceramic green sheet, thus rapidly fabricating a mother laminate for manufacturing desired electronic components.

### TECHNICAL FIELD

The present invention relates to a method of manufacturing electronic components, and more particularly, to a method of manufacturing ceramic electronic components at a high speed through a printing process, comprising simultaneously printing a ceramic dielectric region and a conductive region on a support film.

### BACKGROUND ART

Recently, the decrease in the size and weight of electronic products and related components is receiving attention as a very important technical goal. To this end, it is essential that the wire density of a substrate be increased and that the size and weight of individual components and modules be decreased, and accordingly, novel component fabrication techniques have been proposed.

The component fabrication techniques include the fabrication of multilayer chip components using low temperature co-fired ceramic (LTCC) or high temperature co-fired ceramic (HTCC).

For example, in the manufacture of a multilayer ceramic capacitor, a process of gravure-printing a ceramic paste and a conductive paste on a ceramic green sheet supported on a support film is known. Japanese Unexamined Patent Publication No. Hei. 8-250370 discloses a method of manufacturing a multilayer ceramic capacitor, comprising gravure-printing a plurality of internal electrode patterns on a dielectric green sheet formed on a long rectangular support film using a first gravure printing roll, and then gravure-printing dielectric patterns to enable a stepped surface formed by the internal electrode patterns to be flush therewith using a second gravure printing roll.

However, the Japanese patent suffers from problems of dislocation of the dielectric green sheet in a transverse direction (the direction perpendicular to the direction of conveyance of the dielectric green sheet) at the time of gravure-printing the internal electrode patterns and the dielectric patterns for flattening a stepped surface on the long rectangular dielectric green sheet using the gravure printing rolls. In order to solve the above problem, Korean Patent Application No. 2004-11789 discloses a method of manufacturing ceramic electronic components, comprising preparing a long rectangular composite sheet including a support film and a ceramic green sheet formed thereon, conducting first gravure printing to print a first paste on a first area of a print region on the ceramic green sheet, and then conducting second gravure printing to print a second paste on a second area of the print region on the ceramic green sheet. The above method is characterized in that a first print mark is formed on the ceramic green sheet or support film in the course of first gravure printing, after which, depending on the result of comparison of the position of the first print mark thus formed with the desired first print mark position, the second gravure printing is conducted.

As mentioned above, in the manufacture of the electronic component, such as the multilayer ceramic capacitor, the process of gravure-printing the ceramic paste and the conductive paste on the ceramic green sheet supported on the support film is known, but has a technical construction using the ceramic green sheet in a manner such that a previously formed ceramic green sheet is used, or a ceramic green sheet is formed on the support film. In this regard, as illustrated in FIG. 1, procedures of forming a ceramic green sheet (dielectric layer) 72 on a support film 71, forming conductive internal electrodes 73 on the ceramic green sheet, and then forming a ceramic layer 74 for flattening a stepped surface must be carried out, undesirably making it impossible to produce ceramic electronic products at a high speed.

Further, Korean Patent Application No. 2004-11789 discloses the method of manufacturing the ceramic electronic components, including forming the print mark in the print region to precisely correct the print position error, and correcting the position of the ceramic green sheet in longitudinal and transverse directions depending on the result of comparison of the position of the print mark. However, the above method is problematic in that position control is realized using a print mark corresponding to a single print pattern, which is formed by the printing roll, and thus is not precise.

### DISCLOSURE OF INVENTION

### Technical Problem

Leading to the present invention, thorough research into simplifying conventional processes of manufacturing electronic components through gravure printing, conducted by the present inventors, led to the development of a method of simultaneously printing a first pattern of a print region and a ceramic dielectric layer on a support film without the use of an additional ceramic green sheet and a printing method for correcting and controlling print position error with higher precision.

Accordingly, an object of the present invention is to provide a method of manufacturing electronic components at a high speed through a gravure printing process, in which a ceramic dielectric layer and a first pattern of a print region are simultaneously printed on a support film, without the use of an additional ceramic green sheet or an additional ceramic green sheet formation process, thus reducing the manufacturing process and decreasing the manufacturing cost and the manufacturing time.

Another object of the present invention is to provide a method of manufacturing electronic components at a high speed through a gravure printing process, in which a plurality of print regions is formed by a printing roll and register marks corresponding to the respective print regions are formed, so that the position error between a first pattern, formed with a ceramic dielectric paste, and a second pattern, formed with a conductive paste, is corrected and controlled with high precision.

A further object of the present invention is to provide a method of manufacturing electronic components at a high speed through a gravure printing process, in which a continuous process is realized using a plurality of printing units for simultaneously printing a ceramic dielectric layer and a first pattern of a print region on a support film, thereby rapidly fabricating a mother laminate for use in manufacturing desired electronic components.

### Technical Solution

In order to accomplish the above objects, the present invention provides a method of manufacturing ceramic electronic components through a printing process, comprising forming a ceramic dielectric region, in which a ceramic dielectric layer and a first pattern of a print region are simultaneously formed; and forming a conductive region, in which a second pattern of the print region is formed on a surface of the cer amic dielectric region.

The forming the ceramic dielectric region may comprise first gravure printing, by which a ceramic dielectric paste is printed on a surface on which the ceramic dielectric region is to be formed so as to simultaneously form the ceramic dielectric layer and the first pattern composed of protrusions which protrude from the ceramic dielectric layer.

The forming the conductive region may comprise second gravure printing, by which a conductive paste is printed on a portion of the ceramic dielectric layer, other than the first pattern, thus forming the second pattern, which is the conductive region.

The first gravure printing may be conducted using a first gravure printing roll, in which a printing section of the printing roll has a recessed area recessed to a depth corresponding to a thickness of the ceramic dielectric layer plus a thickness of the first pattern from a surface of the printing roll, and a portion of the recessed area, corresponding to the first pattern, has protrusions which protrude from the recessed area to a height corresponding to a thickness of the first pattern.

The second gravure printing may be conducted using a second gravure printing roll, in which a printing section of the printing roll has recesses recessed to a depth corresponding to a thickness of the second pattern from a surface of the printing roll.

The first pattern and the second pattern may have identical thicknesses and may be formed to be adjacent to each other.

In the method, the forming the ceramic dielectric region and the forming the conductive region may be continuously repeated on a support film which is prepared, thus forming a mother laminate.

In addition, the present invention provides a method of manufacturing ceramic electronic components through a printing process, comprising forming a plurality of ceramic dielectric regions, in which a ceramic dielectric layer and first patterns of a plurality of print regions are formed and simultaneously first register marks corresponding to the respective ceramic dielectric regions are formed; and forming a plurality of conductive regions, in which second patterns of the print regions, which are the conductive regions, are formed on a surface of the plurality of ceramic dielectric regions and simultaneously second register marks corresponding to the respective conductive regions are formed.

The method may further comprise comparing a position of the first register marks with a position of the second register marks, spaced apart therefrom at predetermined intervals, and then, depending on a comparison value, in a case where a position error is generated in a longitudinal direction, correcting the position error in the longitudinal direction, or in a case where a position error is generated in a transverse direction, correcting the position error in the transverse direction.

That is, whether the interval between the position of the first register mark and the position of the second register mark is constant (e.g., 2 cm), as in the printing roll, is checked. As such, if the interval between the first and second register marks is smaller or larger than the constant interval (2 cm) in a longitudinal direction, an error is generated in a longitudinal direction. In order to correct the error, the position error in the longitudinal direction is corrected through the change in the speed of the second printing roll. In the case where the second register mark is slanted to the left or right relative to the center of the first register mark, a position error is generated in a transverse direction. In this case, the second printing roll is moved in the direction opposite the error direction by a distance corresponding to the position error, using a moving device mounted to the second printing roll, thus compensating the position error in the transverse direction.

The forming the ceramic dielectric regions may comprise first gravure printing, by which a ceramic dielectric paste is printed on a surface on which the ceramic dielectric regions are to be formed, thus simultaneously forming the ceramic dielectric layer and the first patterns composed of protrusions which protrude from the ceramic dielectric layer, and forming the first register marks outside the plurality of print regions to correspond to the respective print regions.

The forming the conductive regions may comprise second gravure printing, by which a conductive paste is printed on a portion of the ceramic dielectric layer other than the first patterns, thus simultaneously forming the second patterns, which are the conductive regions, and forming the second register marks outside the plurality of print regions to correspond to the respective print regions.

The first gravure printing may be conducted using a first gravure printing roll having a plurality of printing sections formed on an outer surface thereof, in which each of the plurality of printing sections has a recessed area recessed to a depth corresponding to a thickness of the ceramic dielectric layer from the outer surface of the printing roll, a portion of the recessed area corresponding to the first patterns has protrusions protruding from the recessed area to a height corresponding to a thickness of the first patterns, and first register mark printing portions for forming the plurality of first register marks are formed at predetermined intervals outside the plurality of printing sections to correspond to the respective printing sections.

The second gravure printing may be conducted using a second gravure printing roll having a plurality of printing sections formed on an outer surface thereof, in which each of the printing sections has recesses recessed to a depth corresponding to a thickness of the second patterns from the outer surface of the printing roll, and second register mark printing portions for forming the plurality of second register marks are formed at predetermined intervals outside the plurality of printing sections to correspond to the respective printing sections.

The plurality of first register marks may be formed to be adjacent to the plurality of second register marks to thus form pairs of first and second register marks, and the pairs of first and second register marks may be spaced apart from each other at predetermined intervals.

The correcting the position error in the longitudinal direction may comprise multiplying a difference between a time required to recognize the first register marks and a time required to recognize the second register marks, adjacent thereto, by a predetermined printing speed, to thus calculate the position error in the longitudinal direction; and changing a speed of the second gravure printing roll to correct the position error.

The correcting the position error in the transverse direction may comprise comparing a time required to recognize the first register marks when passing the first register marks through a sensor and a time required to recognize the second register marks when passing the second register marks through a sensor to thus calculate the position error in the transverse direction on a basis of a time difference; and moving the second gravure printing roll in a direction opposite a direction in which the position error in the transverse direction is generated, to correct the position error in the transverse direction.

### ADVANTAGEOUS EFFECTS

According to the present invention, the method of manufacturing ceramic electronic components exhibits superior effects, as explained below.

First, according to the method of rapidly manufacturing the ceramic electronic components of the present invention, a ceramic dielectric layer and a first pattern of a print region can be simultaneously printed on a support film without the use of an additional ceramic green sheet or an additional ceramic green sheet formation process, thus reducing the manufacturing process and decreasing the manufacturing cost and the manufacturing time.

Second, according to the method of rapidly manufacturing the ceramic electronic components of the present invention, a plurality of print regions can be formed by a printing roll, and register marks corresponding to the respective print regions can be formed, thereby correcting and controlling print position error between a first pattern formed with a ceramic dielectric material and a second pattern formed with a conductive paste, and also decreasing the size of the portion that is misprinted and thus cannot be used although the erroneous portion is corrected.

Third, according to the method of rapidly manufacturing the ceramic electronic components of the present invention, a continuous process can be realized using a plurality of printing units for simultaneously printing a ceramic dielectric layer and a first pattern of a print region on a support film, thereby rapidly fabricating a mother laminate for use in manufacturing desired electronic components.

### BRIEF DESCRIPTION OF THE DRAWINGS

FIG. 1 is a schematic cross-sectional view illustrating a ceramic capacitor manufactured through a conventional process of manufacturing ceramic electronic components;

FIG. 2 is a schematic view illustrating a roll-to-roll unit for conducting first gravure printing and second gravure printing according to the present invention

FIGS. 3 and 4 are perspective views illustrating a first gravure printing roll for conducting first gravure printing and a second gravure printing roll for conducting second gravure printing, respectively, according to the present invention

FIG. 5 is a cross-sectional view illustrating a ceramic dielectric region printed on a support film through first gravure printing;

FIG. 6 is a cross-sectional view illustrating the ceramic dielectric region and the conductive region (internal electrode) formed through second gravure printing, conducted after the first gravure printing as in FIG. 5;

FIGS. 7 and 8 are schematic views illustrating a device for recognizing a register mark to control a printing roll;

FIG. 9 is a view illustrating output signals in response to two marks recognized by a sensor;

FIGS. 10 and 11 are schematic views illustrating the position of a register mark in the case where there is a position error in a transverse direction, and the position of a register mark in the case where there is no position error in a longitudinal direction or in a transverse direction;

FIG. 12 is a view illustrating a process of correcting the position error in a transverse direction through movement of a second gravure printing roll in an axial direction at the time of one rotation thereof;

FIG. 13 is a schematic view illustrating a device for moving the second gravure printing roll in an axial direction; and

FIG. 14 is a view illustrating a state in which a ceramic dielectric region and a conductive region are printed through one rotation of a first gravure printing roll and a second gravure printing roll, and pluralities of first and second register marks are printed on a support film to control the print positions of the above respective regions.

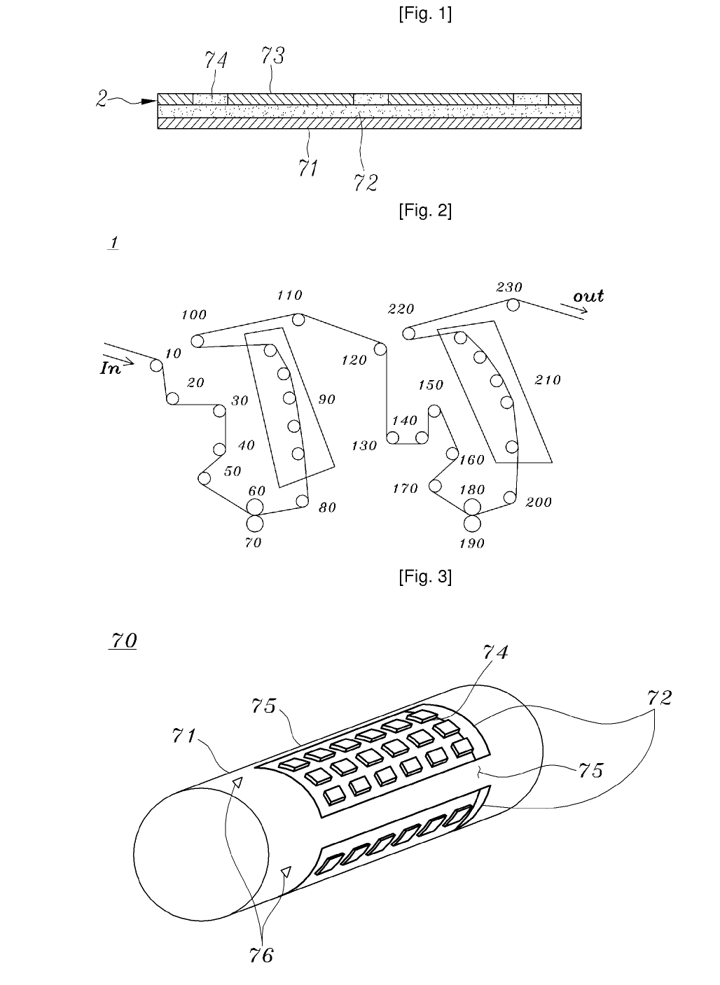

### MODE FOR THE INVENTION

Hereinafter, a detailed description will be given of the technical construction of the present invention with reference to the accompanying drawings.

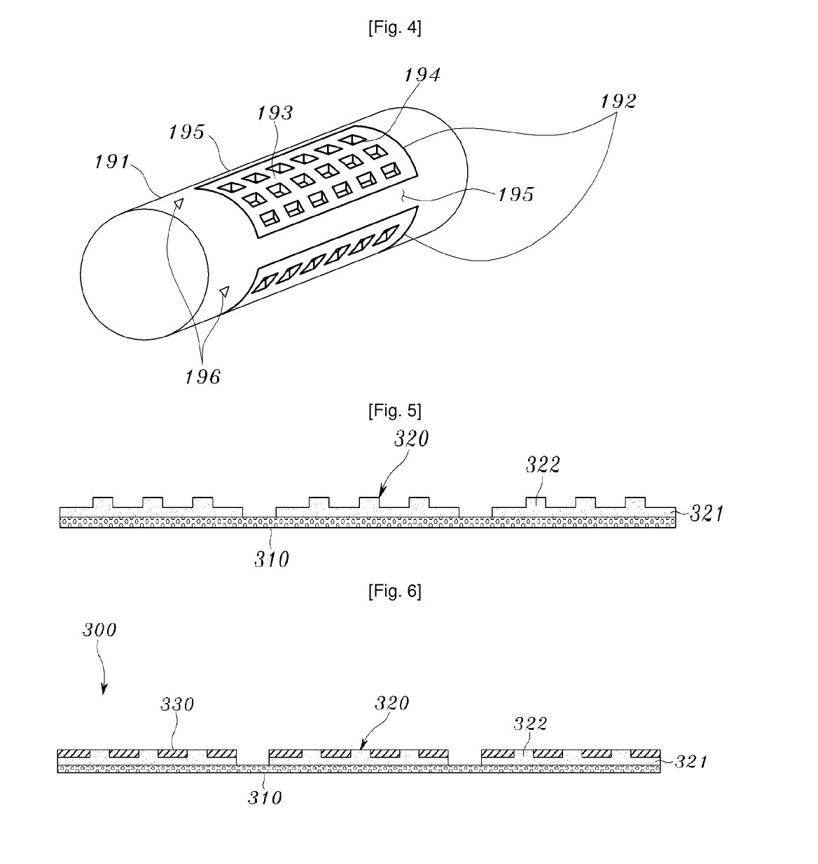

FIG. 2 is a schematic view illustrating a roll-to-roll unit for conducting first gravure printing and second gravure printing according to the present invention, FIGS. 3 and 4 are perspective views illustrating a first gravure printing roll for conducting first gravure printing and a second gravure printing roll for conducting second gravure printing, respectively, FIG. 5 is a cross-sectional view illustrating a ceramic dielectric region printed on a support film through first gravure printing, and FIG. 6 is a cross-sectional view illustrating the ceramic dielectric region and the conductive region (internal electrode) formed through second gravure printing, conducted after the first gravure printing as in FIG. 5.

In a general apparatus for manufacturing multilayer ceramic electronic components for multilayer capacitors, a composite sheet, having a support film formed of synthetic resin, such as polyethylene terephthalate, polypropylene, or polyethylene naphthalate, and a ceramic green sheet formed thereon, is supplied as shown in the arrow. However, according to the present invention, a support film having no ceramic green sheet is supplied in the direction of the arrow of FIG. 2.

As a constituent unit of the apparatus for manufacturing multilayer ceramic electronic components, a printing unit 1 has first and second gravure printing parts, respectively disposed to conduct printing on one surface of the support film.

The first gravure printing part has a first gravure printing roll 70 in the form of a plate cylinder, and a first impression roll 60. As illustrated in the perspective view of FIG. 3, the first gravure printing roll 70 has a cylindrical shape, and the outer surface 71 thereof has a plurality of first printing sections 72 formed in a circumferential direction. In some cases, only one first printing section 72 need be formed. The plurality of first printing sections 72 is preferably spaced apart from each other in a longitudinal direction so as to have predetermined clearances 75 in the axial direction between the printing sections 72.

The plurality of first printing sections 72 is used to form first patterns of print regions, which are intended to be printed. Each of the plurality of first printing sections 72 has a recessed area 73 recessed to a depth corresponding to the thickness of the ceramic dielectric layer plus the thickness of the first patterns from the surface, that is, the outer surface 71, of the printing roll 70. The portion of the recessed area 73 corresponding to the first patterns of the print regions has protrusions 74 protruding from the recessed area 73 to a height corresponding to the thickness of the first patterns. In the drawing, the protrusions 74 have a rectangular shape, and are formed in a matrix arrangement so that the longitudinal direction thereof is parallel to the rotation direction of the first gravure printing roll 70. Thus, the recessed area 73 may be seen in the form of a lattice-shaped groove, and the protrusions 74 protruding from the recessed area 73 are formed so that the upper surface thereof is lower than the surface, that is, the outer surface 71, of the printing roll 70.

The protrusions 74, that is, the first patterns, are formed so that the stepped surface of the internal electrodes, which are useful for multilayer ceramic electronic components, is flush therewith. The shape thereof varies depending on the shape of the electrodes, which are useful for multilayer ceramic electronic components, and is not limited to the rectangular shape illustrated in the drawing. Further, in FIG. 3, three first printing sections 72 are shown, but the number of printing sections is not limited thereto.

The portion of the outer surface 71 of the first gravure printing roll 70, other than the plurality of first printing sections 72, has first register mark printing portions 76, for forming a plurality of first register marks 340 for correcting the position error of a support film 310 in a longitudinal direction and/or a transverse direction, respectively formed to correspond to the first printing sections 72. The shape of the first register mark printing portions 76 is not particularly limited, and the first register mark printing portions are provided in a plural number corresponding to the number of first printing sections 72, and are preferably formed to be recessed from the outer surface 71 of the printing roll.

Thereby, first gravure printing is conducted in a manner such that the support film 310 is fitted between the gravure printing roll 70 and the impression roll 60 of the first gravure printing part of the printing unit 1, so that a ceramic dielectric paste loaded into the recessed areas 73 of the plurality of first printing sections 72 using means for coating a ceramic dielectric paste, which is not shown, is transferred onto the support film 310. As such, the ceramic dielectric paste may comprise a mixture composed of ceramic powder, including dielectric ceramic, magnetic ceramic, glass, or glass ceramic, and organic vehicles.

The first gravure printing part of the printing unit 1 includes rollers 10˜50 for supplying the support film 310 between the first gravure printing roll 70 and the impression roll 60, as is typical in the art. Through the rollers 10˜50, the support film 310 is supplied between the first gravure printing roll 70 and the impression roll 60. Further, a roller 80 is disposed downstream of the first gravure printing roll 70, and through the roller 80, the support film 310, printed with a plurality of ceramic d ielectric regions, is conveyed to a first drying device 90. The drying device 90 is provided with a heater suitable for drying the printed ceramic dielectric regions. Furthermore, rollers 100, 110 are disposed downstream of the drying device 90. After the printed ceramic dielectric regions are dried, the support film 310 is supplied to the second gravure printing part of the printing unit 1. The second gravure printing part is provided with a second gravure printing roll 190 and a second impression roll 180 to conduct second gravure printing.

As illustrated in FIG. 4, the second gravure printing roll 190 has a cylindrical shape, like the first gravure printing roll 70. The outer surface 191 thereof has a plurality of second printing sections 192 formed in a circumferential direction. In some cases, only one second printing section 192 need be formed. The plurality of second printing sections 192 is preferably spaced apart from each other in a longitudinal direction so as to have predetermined clearances 195 in the axial direction between the second printing sections 192.

With the goal of printing conductive paste on the area on which the first patterns 322 are not formed, of the ceramic dielectric regions 320 of FIG. 5, including the ceramic dielectric layer 321 and the first patterns 322, formed using the first gravure printing roll 70, so as to form a plurality of second patterns 330, which are the conductive regions, as illustrated in FIG. 6, the plurality of second printing sections 192 has a plurality of recesses 193, which have a shape complementary to the shape of the printed first patterns 320 and are in the form of a matrix arrangement so that the longitudinal direction thereof is parallel to the rotation direction of the second gravure printing roll 190, and a surface 191 around the plurality of recesses 193. The recesses 193 constituting the second patterns are recessed to a depth corresponding to the thickness of the second patterns from the surface of the printing roll. The shape of the plurality of recesses 193 constituting the second patterns coincides with the shape of the internal electrodes, which are useful for multilayer ceramic electronic components, and is not limited to a rectangular shape. The first patterns 320 and the second patterns 330 are formed to be adjacent to each other, and preferably have a complementary relationship.

As illustrated in FIG. 4, the second printing sections 192 are formed in the same number as the first printing sections 72. The portion of the outer surface 191 of the second gravure printing roll 190, other than the plurality of second printing sections 192, is provided with second register mark printing portions 196, for forming a plurality of second register marks 350 for correcting the position error of the support film 310 in a longitudinal direction and/or in a transverse direction, respectively formed to correspond to the second printing sections 192. The shape of the second register mark printing portions 196 is not particularly limited, and the second register mark printing portions 196 are provided in a plural number corresponding to the number of second printing sections 192, and are preferably formed to be recessed from the outer surface 191 of the printing roll.

Thereby, second gravure printing is conducted in a manner such that the support film 310 printed with the plurality of ceramic dielectric regions is fitted between the second gravure printing roll 190 and the impression roll 180 of the second gravure printing part, so that a conductive paste, loaded into the recesses 193 of the plurality of second printing sections 192 using means for coating a conductive paste for internal electrodes, which is not shown, is transferred onto the support film 310. The conductive paste used for forming the second patterns 330, which are the conductive regions, is composed of a mixture comprising conductive powder, including Ag, Ag—Pd, Ni, Cu or Au, and organic vehicles.

Further, in order to supply the support film 310 printed with the plurality of ceramic dielectric regions between the second gravure printing roll 190 and the impression roll 180, rollers 120˜170 are disposed, as is typical in the art.

A roller 200 and a second drying device 210 are sequentially disposed downstream of the second gravure printing roll 190. The second drying device 210 is constructed like the first drying device 90. Furthermore, rollers 220, 230 are disposed downstream of the second drying device 210. Thereby, printing is conducted through the first and second printing parts of the printing unit 1, and thus, the support film 310 on which a single layer composed of the ceramic dielectric regions 320 and the conductive regions 330 is formed is discharged in the direction of the arrow.

A sensor for controlling the register is mounted downstream of the second gravure printing roll and upstream of the drying device, and is exemplified by an optical sensor, but is not limited to the optical sensor, and a vision sensor may be used.

In addition, the support film 310, having a single layer composed of the ceramic dielectric regions and the internal electrodes formed thereon, discharged from the printing unit 1, is subsequently conveyed into another printing unit connected to the printing unit 1, thus continuously performing first gravure printing for forming the ceramic dielectric regions and second gravure printing for forming the conductive regions, which are internal electrodes, to thereby form the support film having two layers respectively composed of the ceramic dielectric regions and the internal electrodes. In addition, the support film, having two layers respectively composed of the ceramic dielectric regions and the internal electrodes, discharged from the printing unit, is subsequently conveyed into a further printing unit connected to the printing unit, thereby repeating the process of continuously forming the ceramic dielectric regions and the conductive regions.

Therefore, according to the method of manufacturing the ceramic electronic components of the present invention, the process of subjecting the ceramic dielectric paste and the conductive paste to gravure printing on the support film, without the use of the ceramic green sheet, is repeated, thus rapidly fabricating a mother laminate for manufacturing desired electronic components.

Next, in the case where the ceramic electronic components are desired to be manufactured at a high speed according to the present invention, a method of more precisely controlling the first and second gravure printing rolls to correct and control print position error with high precision is described below.

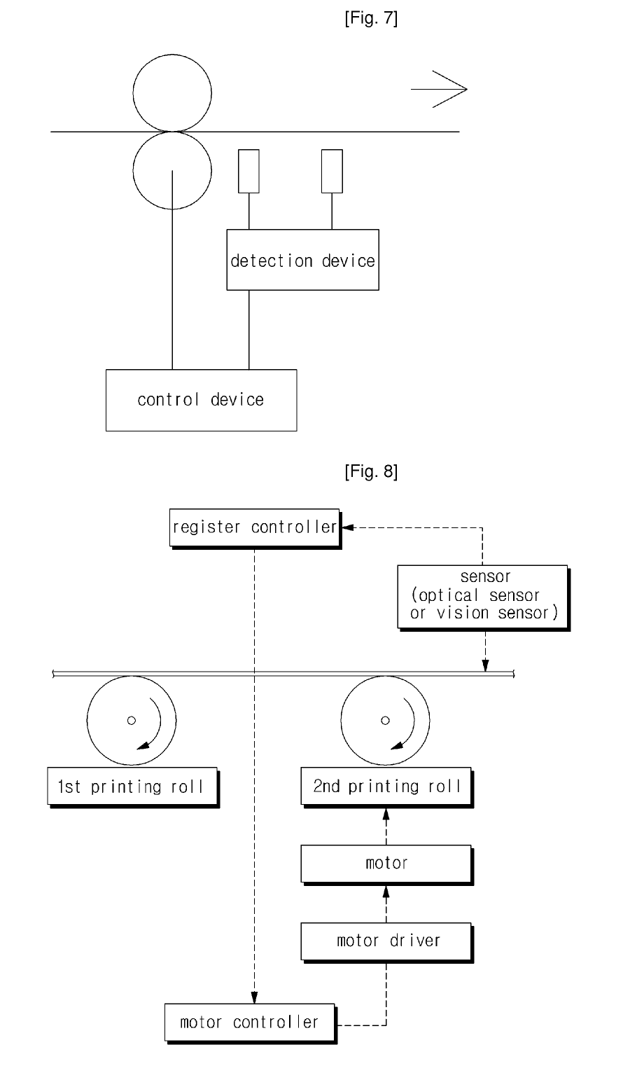

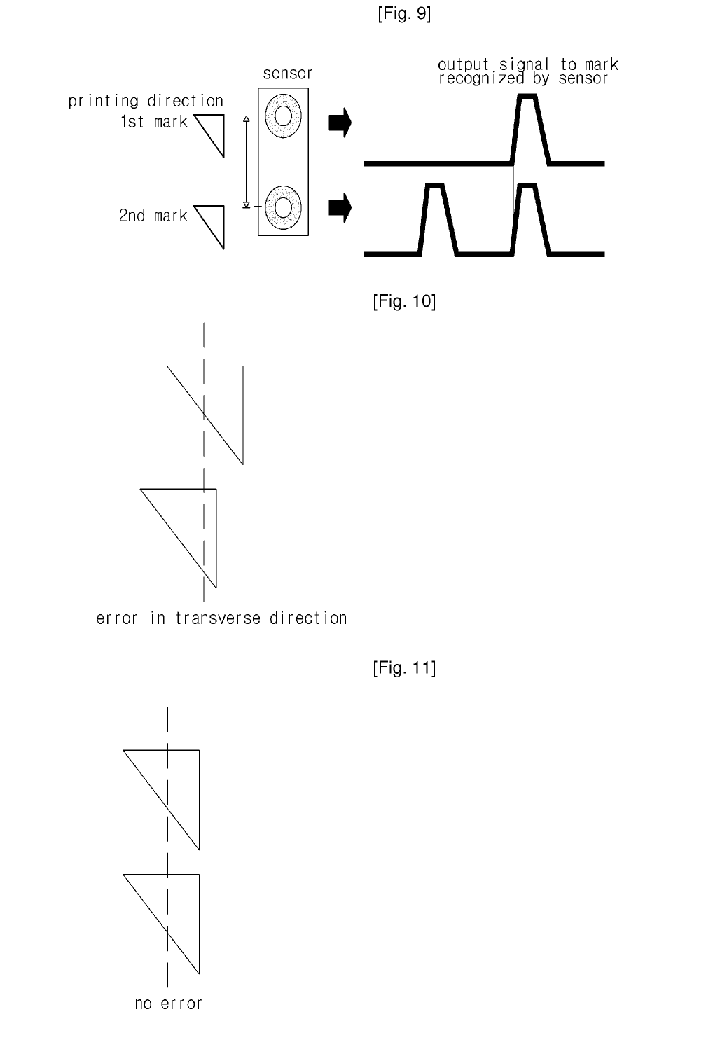

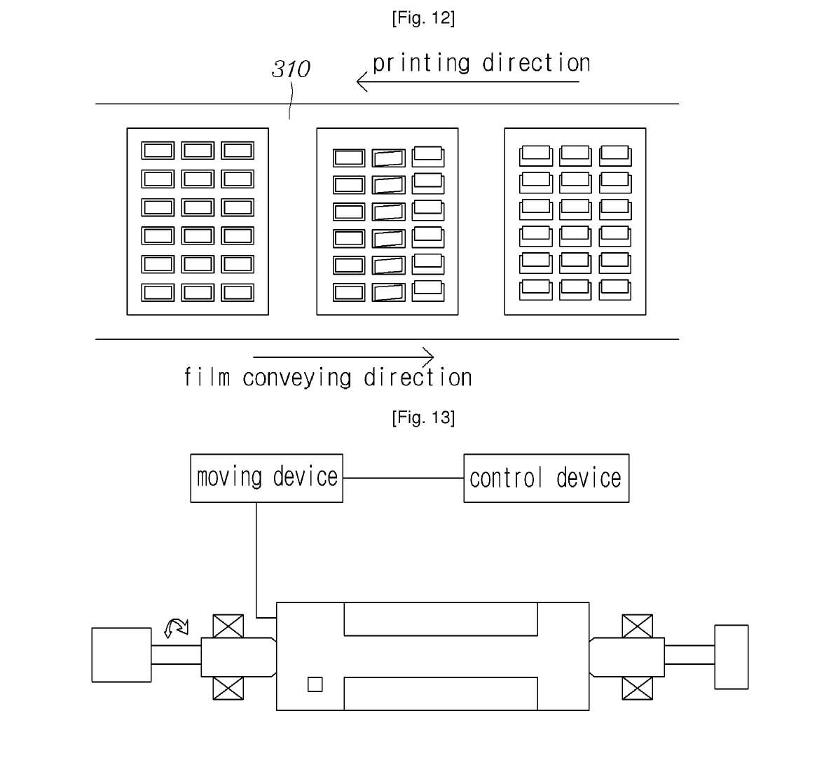

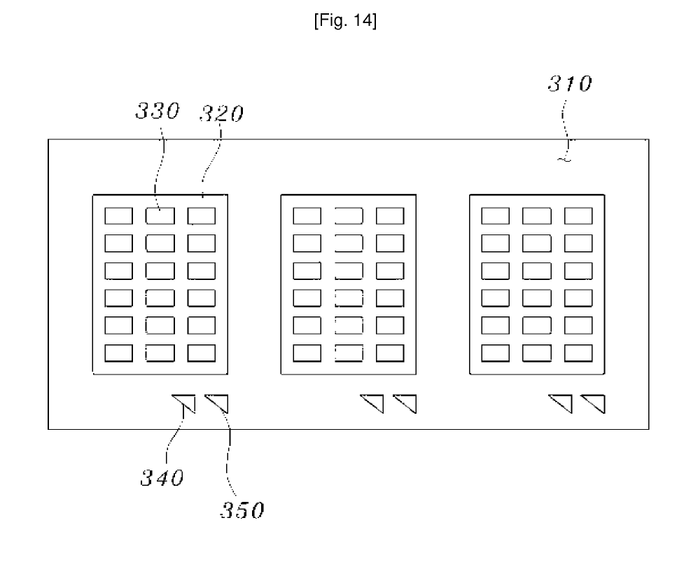

FIGS. 7 and 8 are schematic views illustrating a device for recognizing the register mark to control the printing roll, FIG. 9 is a view illustrating output signals in response to two marks recognized by a sensor, FIGS. 10 and 11 are schematic views illustrating the position of the register mark in the case where there is a position error in a transverse direction, and the position of the register mark in the case where there is no position error in a longitudinal direction or in a transverse direction, FIG. 12 is a view illustrating a process of correcting the position error in a transverse direction through movement of the second gravure printing roll in the axial direction at the time of one rotation thereof, FIG. 13 is a schematic view illustrating a device for moving the second gravure printing roll in the axial direction, and FIG. 14 is a view illustrating a state in which ceramic dielectric regions and conductive regions are printed through one rotation of the first gravure printing roll and second gravure printing roll, and pluralities of first and second register marks are printed on the support film to control the print positions of the above respective regions.

FIGS. 7 and 8 schematically illustrate the device for recognizing the register mark to control the printing roll. As illustrated in FIG. 7, a detection device includes a sensor disposed downstream of the second gravure printing roll to recognize the register mark.

As illustrated in FIG. 8, the sensor for recognizing the register mark, included in the detection device, is an optical sensor, or, alternatively, may be a vision sensor. The detection device is connected to a control device, and the control device includes a register controller and a motor controller. When the register mark is detected by the detection device, a signal in response to the position of the register mark is sent to the control device, that is, the register controller, and in addition, a signal in response to the correction of the position error of the register controller is sent to the motor controller, thus correcting and controlling the position error depending on the speed of the second gravure printing roll or the movement thereof in a transverse direction, as mentioned below.

Referring to FIG. 7, the process of correcting and controlling the error in a longitudinal direction is as follows.

According to the process of detecting the error in a longitudinal direction, when the printing is carried out, the register marks are printed. The interval between the two sensors of the detection device is set to (for example) 20 mm (the interval is not specified and may have any uniform value). In the case where there is no error in a longitudinal direction, the intervals between the register marks are 20 mm.

In FIG. 9, showing the output signals in response to two register marks recognized by two sensors, the time at which the first signal of the first sensor is input and the time at which the second signal of the second sensor is input are compared (the rising edge or falling edge is compared depending on the shape of the register mark).

Then, the position error is calculated by multiplying the difference between the input times of the two signals by the current printing speed. In order to correct the error, the control device is responsible for changing the speed of the second gravure printing roll.

Then, the speed is changed until two subsequent register marks are recognized, after which a new position error is calculated through the subsequently recognized register marks, thus correcting the error.

Next, according to the process of correcting and controlling the error in a transverse direction, when the printing is carried out, the register marks are printed. In the case where a position error in a transverse direction is caused by the second gravure printing roll, the time required to recognize the second register mark, printed by the second gravure printing roll and recognized by the detection device, is longer or shorter than the time required to recognize the first register mark. That is, if the time is longer, the second register mark is slanted to the left.

The position error in a transverse direction is calculated by multiplying the difference between the time required to recognize the first register mark and the time required to recognize the second register mark by the printing speed. To correct the error, the control device plays a role in moving the second gravure printing roll in the transverse direction of the second gravure printing roll.

That is, as illustrated in FIG. 13, in order to correct the position error of the ceramic dielectric regions printed by the first gravure printing roll 70 and the conductive regions for internal electrodes printed by the second gravure printing roll 190 in a transverse direction (which is the direction perpendicular to the direction of conveyance of the support film), the second gravure printing roll 190 is connected with a device for moving it in its axial direction. In the present invention, the printing roll is formed with the plurality of printing sections, and thus, as shown in FIG. 12, during one rotation of the printing roll, the position error may be more rapidly corrected, ultimately decreasing the size of the portion that is misprinted and cannot be used although the erroneous portion is corrected.

As seen in FIG. 14, it is apparent that the ceramic dielectric regions and the conductive regions are printed through one rotation of each of the first and second gravure printing rolls, and furthermore, the plurality of first register marks 340 and the plurality of second register marks 350 for controlling the print positions of the above respective regions are printed on the support film.

That is, in the case where the electronic components are manufactured through a gravure printing process, according to the present invention, the plurality of register mark printing portions and the plurality of printing sections are formed on the printing roll, so that the plurality of register marks is recognized upon one rotation of the printing roll, compared to conventional techniques, in which only one register mark is recognized through one rotation of the printing roll. Thereby, correction may be more efficiently and precisely achieved within a short time, thus decreasing the defect rate.

The moving device, schematically shown in FIG. 13, may include an arbitrary reciprocal driving source for moving the second gravure printing roll at an appropriate distance in the axial direction thereof by the signal from the control device. The reciprocal driving source includes, for example, a reciprocal driving device, such as an air cylinder or a hydraulic cylinder, or a reciprocal driving device including a motor and a combination of a rack and a pinion.

Accordingly, using a system in which the plurality of printing units 1 is continuously connected, the first and second gravure printing rolls can be precisely controlled, thus correcting print position errors with high precision. As well, without the use of the ceramic green sheet or the ceramic green sheet formation process, the ceramic dielectric regions (composed of the ceramic dielectric layer and the first patterns) can be directly formed on the support film, and thus, the process of gravure-printing the ceramic dielectric paste for forming the ceramic dielectric regions and the conductive paste for forming the conductive regions (internal electrodes) can be continuously repeated. As the result, a mother laminate for manufacturing desired electronic components can be fabricated at a high speed.

In the course of manufacturing desired electronic components using the mother laminate, the mother laminate is cut in a thickness direction, thereby obtaining respective laminates for multilayer ceramic capacitor units. Then, the respective laminates for multilayer ceramic capacitor units are sintered, thus obtaining sintered ceramic bodies. External electrodes are formed at opposite ends of the sintered ceramic body, thereby obtaining a multilayer ceramic capacitor. Alternatively, the laminates and the external electrodes may be simultaneously sintered. The sintered body thus obtained is advantageous because structural defects such as delamination do not occur, thus remarkably decreasing the defect rate. In the present invention, in addition to the multilayer ceramic capacitor, the multilayer ceramic electronic components may include multilayer inductors, multilayer noise filters, multilayer LC filters, and multilayer composite modules. In these cases, for example, via holes are formed in a ceramic green sheet, so that internal electrode patterns in a planar shape are connected, consequently forming a circuit device.

### INDUSTRIAL APPLICABILITY

Although the preferred embodiment of the present invention, with regard to the gravure printing process, has been disclosed for illustrative purposes, a flexo printing process may alternatively be applied. Thus, those skilled in the art will appreciate that various modifications, additions and substitutions are possible, without departing from the scope and spirit of the invention as disclosed in the accompanying claims.

1. A method of manufacturing ceramic electronic components through a printing process, comprising:
forming a ceramic dielectric region, in which a ceramic dielectric layer and a first pattern of a print region are simultaneously formed; and
forming a conductive region, in which a second pattern of the print region is formed on a surface of the ceramic dielectric region.

2. The method according to claim 1, wherein the forming the ceramic dielectric region comprises first gravure printing, by which a ceramic dielectric paste is printed on a surface on which the ceramic dielectric region is to be formed so as to simultaneously form the ceramic dielectric layer and the first pattern composed of protrusions which protrude from the ceramic dielectric layer.

3. The method according to claim 1, wherein the forming the conductive region comprises second gravure printing, by which a conductive paste is printed on a portion of the ceramic dielectric layer, other than the first pattern, thus forming the second pattern, which is the conductive region.

4. The method according to claim 2, wherein the first gravure printing is conducted using a first gravure printing roll, in which a printing section of the printing roll has a recessed area recessed to a depth corresponding to a thickness of the ceramic dielectric layer plus a thickness of the first pattern from a surface of the printing roll, and a portion of the recessed area, corresponding to the first pattern, has protrusions which protrude from the recessed area to a height corresponding to a thickness of the first pattern.

5. The method according to claim 3, wherein the second gravure printing is conducted using a second gravure printing roll, in which a printing section of the printing roll has recesses recessed to a depth corresponding to a thickness of the second pattern from a surface of the printing roll.

6. The method according to claim 1, wherein the first pattern and the second pattern have identical thicknesses and are formed to be adjacent to each other.

7. The method according to claim 1, wherein the forming the ceramic dielectric region and the forming the conductive region are continuously repeated on a support film which is prepared, thus forming a mother laminate.

8. A method of manufacturing ceramic electronic components through a printing process, comprising:
forming a plurality of ceramic dielectric regions, in which a ceramic dielectric layer and first patterns of a plurality of print regions are formed and simultaneously first register marks corresponding to the respective ceramic dielectric regions are formed; and
forming a plurality of conductive regions, in which second patterns of the print regions, which are the conductive regions, are formed on a surface of the plurality of ceramic dielectric regions and simultaneously second register marks corresponding to the respective conductive regions are formed.

9. The method according to claim 8, further comprising comparing a position of the first register marks with a position of the second register marks, spaced apart therefrom at predetermined intervals, and then, depending on a comparison value, in a case where a position error is generated in a longitudinal direction, correcting the position error in the longitudinal direction, or in a case where a position error is generated in a transverse direction, correcting the position error in the transverse direction.

10. The method according to claim 8, wherein the forming the ceramic dielectric regions comprises first gravure printing, by which a ceramic dielectric paste is printed on a surface on which the ceramic dielectric regions are to be formed, thus simultaneously forming the ceramic dielectric layer and the first patterns composed of protrusions which protrude from the ceramic dielectric layer, and forming the first register marks outside the plurality of print regions to correspond to the respective print regions.

11. The method according to claim 8, wherein the forming the conductive regions comprises second gravure printing, by which a conductive paste is printed on a portion of the ceramic dielectric layer other than the first patterns, thus simultaneously forming the second patterns, which are the conductive regions, and forming the second register marks outside the plurality of print regions to correspond to the respective print regions.

12. The method according to claim 10, wherein the first gravure printing is conducted using a first gravure printing roll having a plurality of printing sections formed on an outer surface thereof, in which each of the plurality of printing sections has a recessed area recessed to a depth corresponding to a thickness of the ceramic dielectric layer from the outer surface of the printing roll, a portion of the recessed area corresponding to the first patterns has protrusions protruding from the recessed area to a height corresponding to a thickness of the first patterns, and first register mark printing portions for forming the plurality of first register marks are formed at predetermined intervals outside the plurality of printing sections to correspond to the respective printing sections.

13. The method according to claim 11, wherein the second gravure printing is conducted using a second gravure printing roll having a plurality of printing sections formed on an outer surface thereof, in which each of the printing sections has recesses recessed to a depth corresponding to a thickness of the second patterns from the outer surface of the printing roll, and second register mark printing portions for forming the plurality of second register marks are formed at predetermined intervals outside the plurality of printing sections to correspond to the respective printing sections.

14. The method according to claim 8, wherein the plurality of first register marks is formed to be adjacent to the plurality of second register marks to thus form pairs of first and second register marks, and the pairs of first and second register marks are spaced apart from each other at predetermined intervals.

15. The method according to claim 14, wherein the correcting the position error in the longitudinal direction comprises multiplying a difference between a time required to recognize the first register marks and a time required to recognize the second register marks, adjacent thereto, by a predetermined printing speed, to thus calculate the position error in the longitudinal direction; and changing a speed of the second gravure printing roll to correct the position error.

16. The method according to claim 14, wherein the correcting the position error in the transverse direction comprises comparing a time required to recognize the first register marks when passing the first register marks through a sensor and a time required to recognize the second register marks when passing the second register marks through a sensor to thus calculate the position error in the transverse direction on a basis of a time difference; and moving the second gravure printing roll in a direction opposite a direction in which the position error in the transverse direction is generated, to correct the position error in the transverse direction.
